(19) United States
(12) Patent Application Publication
(10) Pub. No.: US 2011/0011991 A1
(43) Pub. Date: Jan. 20, 2011

(54) HEIGHT ADJUSTMENT APPARATUS

(76) Inventor: Ki-Beom Lee, Seoul (KR)

Correspondence Address: IPLA P.A., 3550 WILSHIRE BLVD., 17TH FLOOR, LOS ANGELES, CA, 90010, US

(21) Appl. No.: 12/666,614

(22) PCT Filed: Nov. 6, 2009
(86) PCT No.: PCT/KR09/06500

§ 371 Date: Dec. 23, 2009

(30) Foreign Application Priority Data
Nov. 19, 2008 (KR) 10-2008-0115172
Oct. 26, 2009 (KR) 10-2009-0101630

(51) Int. Cl. F16M 11/24

(52) U.S. Cl. 248/157; 248/422

(57) ABSTRACT

Disclosed herein is a height adjustment apparatus which is constructed such that the height of an upper board placed thereon is easily adjusted only by lifting the upper board. To achieve the above-mentioned purpose, the height adjustment apparatus includes an actuating unit which controls the height of the apparatus, and a frame unit which is coupled to the actuating unit and is adjusted in height by contraction or extension.

### CROSS REFERENCES

Applicant claims priority of International Application No. PCT/KR2009/006500 filed Nov. 6, 2009, which claims foreign priority of Korean Patent Application No. 10-2008-0115172, filed Nov. 19, 2008, and Korean Patent Application No. 10-2009-0101630, filed Oct. 26, 2009, with the Korean Intellectual Property Office, where the entire contents are incorporated herein by reference.

### BACKGROUND OF THE INVENTION

1. Field of the Invention

The present invention relates generally to height adjustment apparatuses and, more particularly, to a height adjustment apparatus which is constructed such that the height of an upper board placed thereon is easily adjusted just by lifting the upper board.

2. Description of the Related Art

Generally, a height adjustment apparatus enables the height of an upper board placed thereon to be adjusted according to a body type of a user such that the user conveniently uses the upper board.

For instance, a representative example of a conventional height adjustment apparatus was proposed in Korean Patent Registration No. 10-0500162 which is shown in FIG. 1.

As shown in FIG. 1, in the conventional height adjustment apparatus, a hinge 38 having a basic structure is connected to two support legs 32 at a junction between the support legs 32. A separate retaining bar 46 for maintaining the height adjustment apparatus at an adjusted height is coupled to the support legs 32.

To adjust the height of the height adjustment apparatus having the above-mentioned structure, a user holds one of the support legs 32 using one of his/her hands, manipulates the retaining bar 46 using the other hand, adjusts the height of the height adjustment apparatus, and then fastens the support legs 32 to each other using the retaining bar 46. However, as such, the process of adjusting the height of the height adjustment apparatus is very complex and thus inconveniences the user. Furthermore, the process and assembly of the steel structure increase the production cost and rate of defectives.

### SUMMARY OF THE INVENTION

Accordingly, the present invention has been made keeping in mind the above problems occurring in the prior art, and an object of the present invention is to provide a height adjustment apparatus which is constructed such that the height thereof is adjusted in multi-steps using a gear teeth engagement structure, and when an upper board reaches the uppermost position, the gear teeth are disengaged from each other, thus enabling the height adjustment apparatus to be contracted such that the upper board is disposed at the lowermost position, thereby enabling a user to easily adjust the upper board without requiring manipulation of a separate height adjustment means.

Another object of the present invention is to provide a height adjustment apparatus in which second and third brackets are coupled to a first bracket which is disposed therebetween and are elastically supported by second and third support rods which are fastened to the second and third brackets, so that because the second and third elastic rods function as elastic members, a separate coupling means for coupling the brackets is not required, thus simplifying the structure of the height adjustment apparatus, thereby reducing the production cost, and facilitating the maintenance and repair thereof.

In other words, the second and third support rods are slightly bent inwards based on the positions at which they are fastened to the second and third brackets. Thus, the second and third brackets can be fastened to both ends of the first bracket by the elastic force of the second and third support rods.

A further object of the present invention is to provide a height adjustment apparatus in which first one-way stoppers are provided in the first bracket, so that when the second and third brackets rotate in a predetermined direction, the first one-way stoppers allow the second and third brackets to rotate around the first bracket which is interposed therebetween, in other words, when the second and third brackets rotate in a predetermined direction within a predetermined range, the gear teeth are disengaged from each other, thus enabling the height adjustment apparatus to be easily contracted.

In order to accomplish the above object, the present invention provides a height adjustment apparatus, including: an actuating unit controlling a height of the height adjustment apparatus; and a frame unit coupled to the actuating unit, the frame unit being adjusted in height by contraction or extension thereof.

The actuating unit may include: a first bracket provided at a medial portion of the actuating unit; a second bracket coupled to a first end of the first bracket; and a third bracket coupled to a second end of the first bracket.

The first bracket may have a cylindrical shape. First coupling parts may be respectively provided on upper and lower portions of the circumferential outer surface of the first bracket. A mounting plate may be provided in the first end of the first bracket. A first gear-teethed part may be provided on the mounting plate. A pair of first protrusions may be provided at diametrically opposite positions on the circumferential outer surface of the first gear-teethed part. The first protrusions extend predetermined lengths outside the first gear-teethed part.

Furthermore, mounting depressions are formed in a circumferential inner surface of both ends of the first bracket, each mounting depression having a predetermined depth, and first locking members are provided in the mounting depression which is adjacent to the second bracket, the first locking members being disposed at positions perpendicular to the first protrusions based on a center of the first bracket.

In addition, a first one-way stopper may be provided on the mounting plate. The first one-way stopper may be disposed inside the first gear-teethed part.

As well, a mounting block may be fastened to the mounting plate of the first bracket. The first one-way stopper may be rotatably coupled to the mounting block by a hinge. An elastic member may be fitted over the hinge.

Moreover, a support protrusion may be provided on the mounting block so that the hinge is fitted into the support protrusion. A stop protrusion may be provided on the mounting block on one side of the support protrusion. An inclined surface may be formed on a first side of the first one-way stopper.

The elastic member may comprise a torsion spring.

The first one-way stopper may comprise three first one-way stoppers spaced apart from each other at regular angular intervals.

The second bracket may have a cylindrical shape and be inserted into the mounting depression formed in the first end of the first bracket. Second coupling parts may be respectively provided on upper and lower portions of the circumferential outer surface of the second bracket. A mounting surface may be formed inside the second bracket. A second gear-teethed part may be provided on the mounting surface. The second gear-teethed part engages with the first gear-teethed part of the first bracket. A locking depression may be formed in the mounting surface and disposed inside the second gear-teethed part so that the first one-way stopper is removably locked to the locking depression. Second locking members may be provided in the second bracket and disposed outside the second gear-teethed part. The second locking members correspond to the first protrusions of the first bracket.

Furthermore, second protrusions corresponding to the first locking members of the first bracket may protrude from a second end of the second bracket in an axial direction.

As well, an inclined surface may be formed in one end of the locking depression.

The height adjustment apparatus may further include a cover covering a first end of the second bracket which is opposite to the second end thereof in which the mounting surface is provided.

The third bracket may have a cylindrical shape and be inserted into the mounting depression formed in the second end of the first bracket. Third coupling parts may be provided at diametrically opposite positions on the circumferential outer surface of the third bracket.

The frame unit may include: a first support rod coupled to the first bracket of the actuating unit; a second support rod coupled to the second bracket of the actuating unit; and a third support rod coupled to the third bracket of the actuating unit.

The first support rod may be inserted through the first coupling parts provided on the upper and lower portions of the first bracket, such that the first support rod protrudes upwards and downwards from the first bracket. The second support rod may be inserted through the second coupling parts provided on the upper and lower portions of the second bracket, such that the second support rod protrudes upwards and downwards from the second bracket. The third support rod may be inserted through the third coupling parts provided on the upper and lower portions of the third bracket, such that the third support rod protrudes upwards and downwards from the third bracket.

In addition, a connection member may be coupled to an upper end of the first support rod. The connection member may be fastened to an upper board. A first bottom support may be coupled to a lower end of the first support rod. The first bottom support may be supported on the ground.

The second and third support rods may be respectively coupled to the second and third brackets. Upper and lower ends of the second and third support rods which protrude from the second and third brackets may be curved inwards such that a distance between the second and third support rods is reduced from the second and third brackets to the upper and lower ends thereof.

Moreover, a top support may be coupled to the upper ends of the second and third support rods. The top support may support the upper board thereon. A second bottom support may be coupled to the lower ends of the second and third support rods. The second bottom support may be supported on the ground.

In order to accomplish the above object, the present invention provides a height adjustment apparatus, including: a fourth bracket, having a fourth bracket body, fourth coupling parts provided on the fourth bracket body so that a fourth support bar is inserted through the fourth coupling parts and passes through the fourth bracket body, a third gear-teethed part having an annular shape and provided in the fourth bracket body, a plurality of locking protrusions provided in the fourth bracket body around a periphery of the third gear-teethed part at positions spaced apart from each other at regular angular intervals, each of the locking protrusions having an inclined portion, and a plurality of depressions formed in the fourth bracket body around the periphery of the third gear-teethed part at positions spaced apart from each other at regular angular intervals; a fifth bracket, having a fifth bracket body, fifth coupling parts provided on the fifth bracket body so that a fifth support bar is inserted through the fifth coupling parts and passes through the fifth bracket body, a fourth gear-teethed part having an annular shape and provided in the fifth bracket body, and a plurality of locking protrusions provided in the fifth bracket body around a periphery of the fourth gear-teethed part at positions spaced apart from each other at regular angular intervals, wherein the fourth bracket is coupled to a first end of the fifth bracket such that the third gear-teethed part engages with the fourth gear-teethed part; second one-way stoppers provided in the fifth bracket around the periphery of the fourth gear-teethed part at positions spaced apart from each other at regular angular intervals, each of the second one-way stoppers being constructed such that an upper end thereof is elastically bent only in one direction; and a sixth bracket coupled to a second end of the fifth bracket, the sixth bracket having a sixth bracket body, and sixth coupling parts provided on the sixth bracket body so that a sixth support bar is inserted through the sixth coupling parts and passes through the sixth bracket body. Upper ends of the fourth and sixth support rods and lower ends of the fourth and sixth support rods are respectively fastened to top and bottom supports.

In order to accomplish the above object, the present invention provides a height adjustment apparatus, including: a fourth bracket, having a fourth bracket body, fourth coupling parts provided on the fourth bracket body so that a fourth support bar is inserted through the fourth coupling parts and passes through the fourth bracket body, a third gear-teethed part having an annular shape and provided in the fourth bracket body, and a plurality of locking protrusions provided in the fourth bracket body around a periphery of the third gear-teethed part at positions spaced apart from each other at regular angular intervals, a fifth bracket, having a fifth bracket body, fifth coupling parts provided on the fifth bracket body so that a fifth support bar is inserted through the fifth coupling parts and passes through the fifth bracket body, a fourth gear-teethed part having an annular shape and provided in the fifth bracket body, and a plurality of locking protrusions provided in the fifth bracket body around a periphery of the fourth gear-teethed part at positions spaced apart from each other at regular angular intervals, each of the locking protrusions having an inclined portion, and a plurality of depressions formed in the fifth bracket body around the periphery of the fourth gear-teethed part at positions spaced apart from each other at regular angular intervals, wherein the fourth bracket is coupled to a first end of the fifth bracket such that the third gear-teethed part engages with the fourth gear-teethed part; second one-way stoppers provided in the fourth bracket around the periphery of the third gear-teethed part at positions spaced apart from each other at regular angular intervals, each of the second one-way stoppers being constructed such that an upper end thereof is elastically bent only in one direction; and a sixth bracket coupled to a second end of the fifth bracket, the sixth bracket having a sixth bracket body, and sixth coupling parts provided on the sixth bracket body so that a sixth support bar is inserted through the sixth coupling parts and passes through the sixth bracket body. Upper ends of the fourth and sixth support rods and lower ends of the fourth and sixth support rods may be respectively fastened to top and bottom supports.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a conventional height adjustment apparatus;

FIG. 2 is a perspective view illustrating a height adjustment apparatus, according to a first embodiment of the present invention;

FIG. 3 is a front view illustrating the height adjustment apparatus according to the first embodiment of the present invention;

FIG. 4 is a side view illustrating the height adjustment apparatus according to the first embodiment of the present invention;

FIG. 5 is an exploded perspective view of an actuating unit according to the first embodiment of the present invention;

FIGS. 6A and 6B are views showing a first one-way stopper according to the first embodiment of the present invention;

FIGS. 7A and 7B are views illustrating the operation of first and second brackets of the height adjustment apparatus according to the first embodiment of the present invention;

FIGS. 8A and 8B are views illustrating the operation of the first one-way stopper of the height adjustment apparatus according to the first embodiment of the present invention;

FIGS. 9A through 9C are views illustrating the operation of contracting the height adjustment apparatus according to the first embodiment of the present invention;

FIG. 10 is an exploded perspective view illustrating an actuating unit of a height adjustment apparatus, according to a second embodiment of the present invention;

FIG. 11 illustrates the second embodiment of the present invention, showing the actuating unit of FIG. 10 coupled to support rods;

FIG. 12 illustrates the second embodiment of the present invention, showing a fourth bracket;

FIG. 13 illustrates the second embodiment of the present invention, showing a fifth bracket;

FIG. 14 is a detailed view showing a second one-way stopper according to the second embodiment of the present invention; and

FIG. 15 is a view showing the operation of the height adjustment apparatus according to the second embodiment of the present invention.

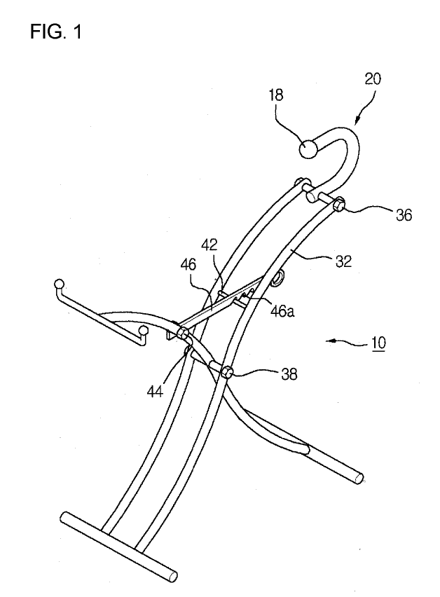

### DESCRIPTION OF THE PREFERRED EMBODIMENTS

Hereinafter, a height adjustment apparatus according to the present invention will be described in detail with reference to the attached drawings.

### First Embodiment

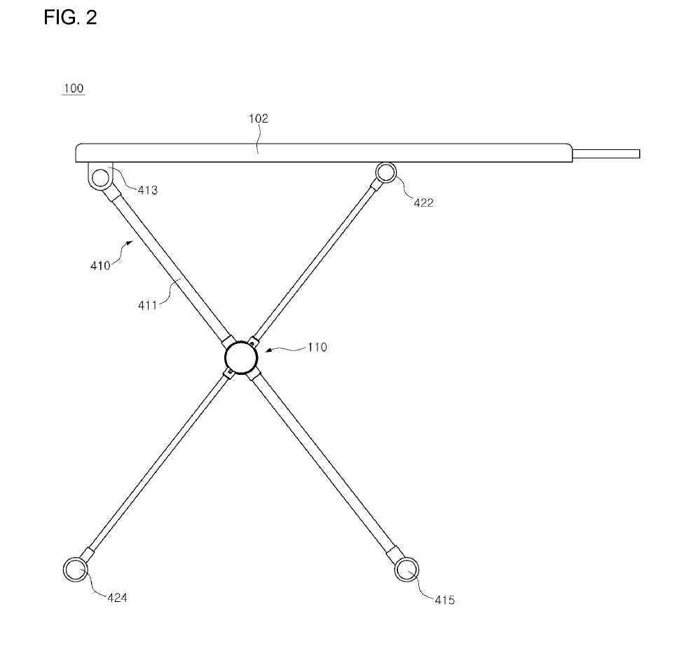

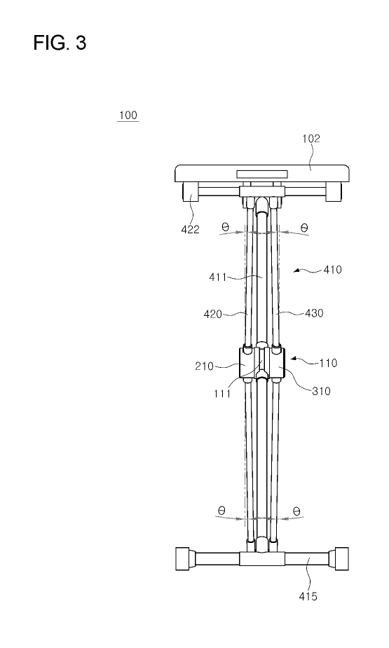

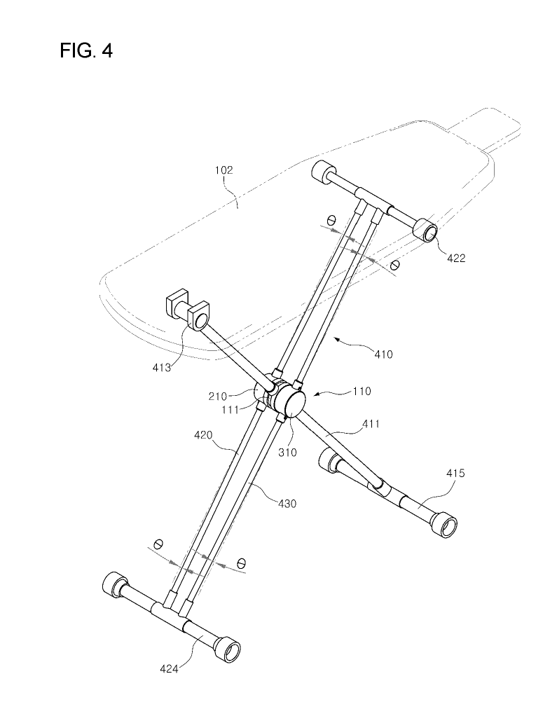

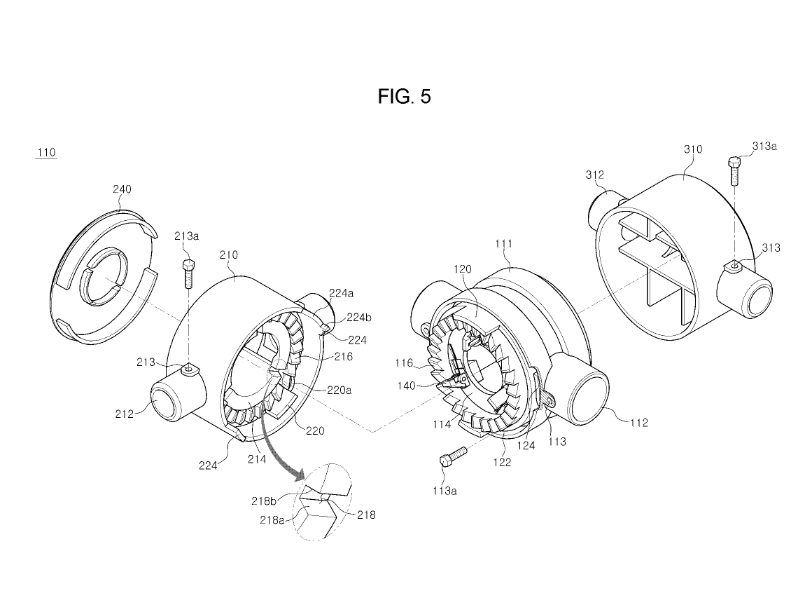

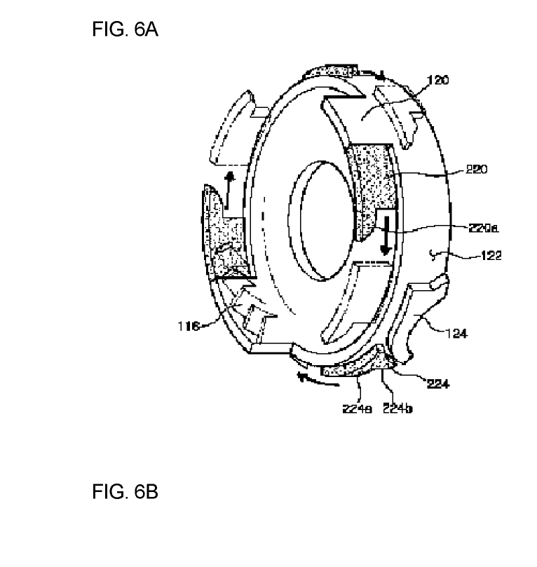

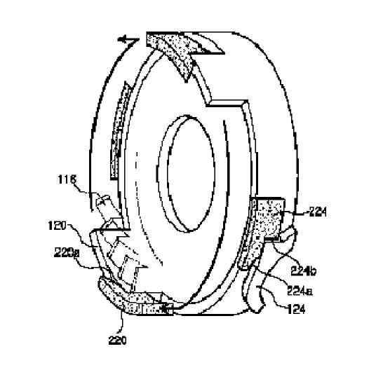

FIG. 2 is a perspective view illustrating a height adjustment apparatus 100, according to a first embodiment of the present invention. FIG. 3 is a front view illustrating the height adjustment apparatus 100. FIG. 4 is a side view illustrating the height adjustment apparatus 100. FIG. 5 is an exploded perspective view of an actuating unit 110 of the height adjustment apparatus 100. FIGS. 6A and 6B are views showing a first one-way stopper 140 of the height adjustment apparatus 100.

As shown in FIGS. 2 through 6, the height adjustment apparatus 100 according to the first embodiment of the present invention includes the actuating unit 110 which controls the height of the height adjustment apparatus 100.

The actuating unit 110 includes a first bracket 111, a second bracket 210 which is coupled to a first end of the first bracket 111, and a third bracket 310 which is coupled to a second end of the first bracket 111.

The first bracket 111 has a cylindrical shape which is open on both ends thereof. First coupling parts 112 symmetrically protrude outwards from upper and lower portions of the circumferential outer surface of the first bracket 111. A screw hole 113 into which a locking bolt 113a is tightened is formed in each first coupling part 112.

Furthermore, a mounting plate 114 is provided in the first end of the first bracket 111. A first gear-teethed part 116 is provided on the outer surface of the mounting plate 114.

Two first protrusions 120 are provided at diametrically opposite positions between the circumferential inner surface of the first bracket 111 and the first gear-teethed part 116. The two first protrusions 120 protrude outwards from the first bracket 111 in the same direction.

In addition, mounting depressions 122 having predetermined depths are formed in the circumferential inner surface of both ends of the first bracket 111. Two first locking members 124 are provided in the mounting depression 122 which is adjacent to the first gear-teethed part 116. The two first locking members 124 are disposed at positions spaced apart from the first protrusions 120 at angles of 90° based on the center of the first bracket 111.

Here, an inclined surface is formed on a first end of each first locking member 124. A locking stop is formed on a second end of the first locking member 124 which is opposite to the inclined surface formed on the first end thereof.

In addition, the first one-way stopper 140 is provided on the mounting plate 114 and disposed inside the first gear-teethed part 116.

To provide the first one-way stopper 140 on the mounting plate 114, a mounting block 118 is mounted to the mounting plate 114. Two support protrusions 118b protrude upwards from opposite sides of the upper surface (when seen in FIG. 6) of the mounting block 118. A hinge 118c is inserted into the two support protrusions 118b. A stop protrusion 118a is provided on the mounting block 118 at one side of the support protrusions 118b.

The first one-way stopper 140 is inserted between the support protrusions 118b and coupled to the mounting block 118 by the hinge 118c. An inclined surface 142 is formed on a first end of the first one-way stopper 140 at a side corresponding to the stop protrusion 118a provided on the mounting block 118. An insert depression 114 is formed in the first one-way stopper 140 at a position opposite the inclined surface 142. An elastic member 146 is provided around the hinge 118c and disposed in the insert depression 144. A first end of the elastic member 146 extends outwards from the first one-way stopper 140 and is supported at a first end thereof on the surface of the mounting plate 114. Thereby, the elastic member 146 elastically supports the first one-way stopper 140.

Preferably, a torsion spring is used as the elastic member 146 which elastically supports the first one-way stopper 140.

In the embodiment, three first one-way stoppers 140 are provided on the mounting plate 114 at positions spaced apart from each other at regular angular intervals in the circumferential direction.

Meanwhile, the second bracket 210 is fitted into the mounting depression 122 of the first bracket 111 which is adjacent to the mounting plate 114.

In detail, the second bracket 210 has a cylindrical shape. Two second coupling parts 212 protrude outwards from the upper and lower portions of the circumferential outer surface of the second bracket 210. A screw hole 213 into which a locking bolt 213a is tightened is formed in each second coupling part 212.

Furthermore, a mounting surface 214 corresponding to the mounting plate 114 of the first bracket 111 is formed inside the second bracket 210. A second gear-teethed part 216 which engages with the first gear-teethed part 116 of the first bracket 111 is formed on the mounting surface 214. In addition, locking depressions 218 are formed in the mounting surface 214 and disposed inside the second gear-teethed part 216. The first one-way stoppers 140 are removably locked to the corresponding locking depressions 218.

Here, an inclined surface 218a is formed in each locking depression 218 at a position corresponding to the inclined surface 142 of the first one-way stopper 140. A stop surface 218b is formed in the locking depression 218 at a position opposite to the inclined surface 218a.

Furthermore, second locking members 220 corresponding to the first protrusions 120 of the first bracket 111 are provided outside the second gear-teethed part 216.

A guide surface 220a is formed on each second locking member 220 at a position opposite to the inclined surface 142 of the first one-way stopper 140 with respect to the direction in which the second locking member 220 rotates.

In addition, second protrusions 224 are provided on the rim of a second end of the second bracket 210 which is inserted into the mounting depression 122 that is formed adjacent to the mounting plate 114 of the first bracket 111. The second protrusions 224 correspond to the first locking members 124 of the first bracket 111.

Here, a guide surface 224a is formed on a front surface (first end) of each second protrusion 224 with respect to the direction in which it is advanced when the second bracket 210 rotates. A locking stop 224b is formed on the second protrusion 224 at a position opposite to the guide surface 224a.

In the embodiment, a cover 240 covers a first end of the second bracket 210 which is opposite to the second end thereof which is coupled to the first bracket 111.

The third bracket 310 is coupled to the second end of the first bracket 111 which is opposite to the second bracket 210.

The third bracket 310 has a cylindrical shape and is fitted at a first end thereof into the mounting depression 122 which is formed in the second end of the first bracket 111 which is opposite to the second bracket 210. The third bracket 310 is sealed on a second end thereof which is opposite to the first end which is coupled to the first bracket 111.

Furthermore, two third coupling parts 312 protrude outwards from the circumferential outer surface of the third bracket 310 at positions corresponding to the second coupling parts 212 of the second bracket 210.

A screw hole 313 is formed in each third coupling part 312. A locking bolt 313a is tightened into the screw hole 313.

In addition, in the present invention, a frame unit 410 is coupled to the actuating unit 100 so that the height thereof is adjusted in height by contracting or extending it.

The frame unit 410 includes a first support rod 411 which is coupled to the first bracket 111, a second support rod 420 which is coupled to the second bracket 210, and a third support rod 430 which is coupled to the third bracket 310.

In detail, the first support rod 411 is inserted into the first coupling parts 112 of the first bracket 111 such that the first support rod 411 passes through the first coupling parts 112 and protrudes upwards and downwards from the first bracket 111. The first support rod 411 which is inserted into the first coupling parts 112 are fastened to the first bracket 111 by the locking bolts 113a which are tightened into the screw holes 113 formed in the first coupling parts 112.

Here, an upper part of the first support rod 411 which protrudes upwards from the first bracket 111 is coupled to a connection member 413 which is fastened to the lower surface of an upper board 102. A lower par of the first support rod 411 which protrudes downwards from the first bracket 111 is coupled to a first bottom support 415 which is placed on the ground.

Furthermore, the second support rod 420 is inserted through the second coupling parts 212 of the second bracket 210 and protrudes upwards and downwards from the second bracket 210, such that the first and second support rods 411 and 420 form an “X”-shaped structure. The second support rod 420 rotates around the actuating unit 110 in the direction in which the first support rod 411 rotates around the actuating unit 110, while maintaining the “X”-shaped structure.

The third support rod 430 is coupled to the third coupling part 312 of the third bracket 310 such that the third support rod 430 protrudes upwards and downwards from the third coupling part 312. The third support rod 430 is oriented in the direction corresponding to the second support rod 420 and rotates in the same direction as that of the second support rod 420.

Here, a distance between the upper and lower parts of the second and third support rods 420 and 430 which protrude upwards and downwards from the second and third brackets 210 and 310 is reduced from the second and third brackets 210 and 310 to both ends of the second and third support rods 420 and 430. In other words, each of the upper and lower parts of the second and third support rods 420 and 430 is slightly bent inwards at an angle of θ such that elastic force is applied to the second and third brackets 210 and 310 towards the first bracket 111.

Thus, the second and third brackets 210 and 310 are brought into close contact with the first bracket 111 by the elastic force of the second and third support rods 420 and 430, so that the second and third brackets 210 and 310 are prevented from becoming removed from the first bracket 111 when the first, second and third brackets 111, 210 and 310 are operated.

Furthermore, a top support 422 is coupled to the upper ends of the second and third support rods 420 and 430 which protrude upwards from the second and third brackets 210 and 310. The upper board 102 is seated onto the top support 422.

In addition, a second bottom support 424 which is placed on the ground is coupled to the lower ends of the second and third support rods 420 and 430 which protrude downwards from the second and third brackets 210 and 310.

As such, the coupling of the second and third brackets 210 and 310 to the first bracket 111 can be reliably retained by the elastic pressing force of the second and third support rods 420 and 430.

In the embodiment, the first, second and third support rods 411, 420 and 430 have been illustrated as being respectively inserted through the first, second and third coupling parts 112, 212 and 312 of the first, second and third brackets 111, 210 and 310 and being protruded upwards and downwards from the first, second and third brackets 111, 210 and 310. However, alternatively, each of the first, second and third support rods 411, 420 and 430 may have a structure such that it is divided into upper and lower parts. In this case, the divided upper and lower parts of the first, second and third support rods 411, 420 and 430 are respectively and independently coupled to the first, second and third coupling parts 112, 212 and 312 which are provided on the upper and lower portions of the first, second and third brackets 111, 210 and 310.

The operation of the height adjustment apparatus 100 according to the first embodiment of the present invention having the above-mentioned construction will be explained below.

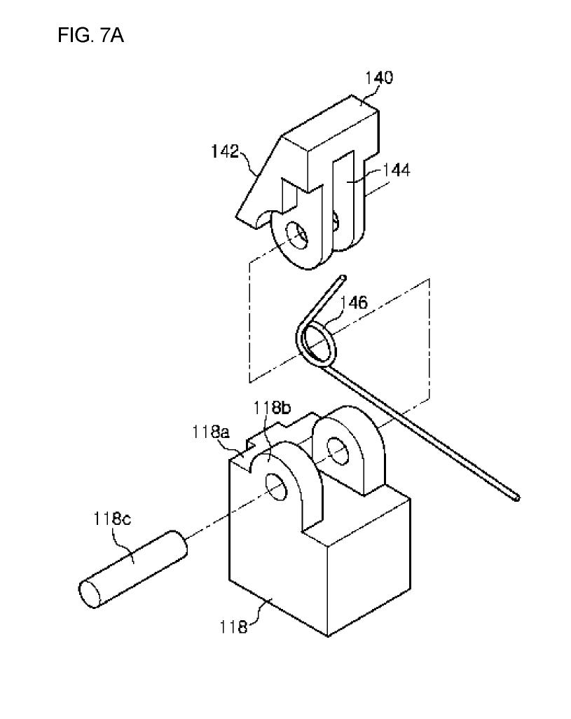

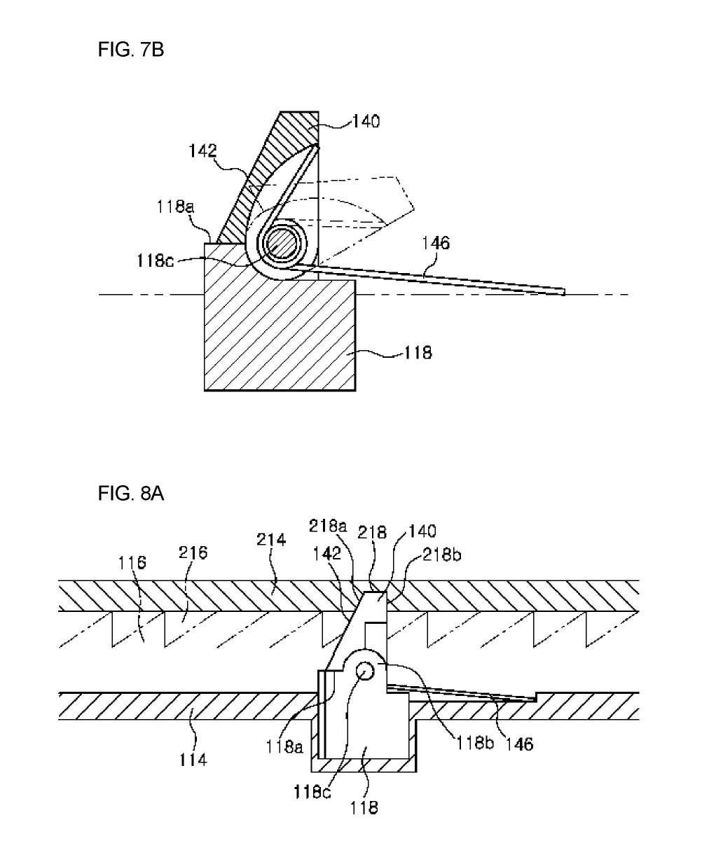

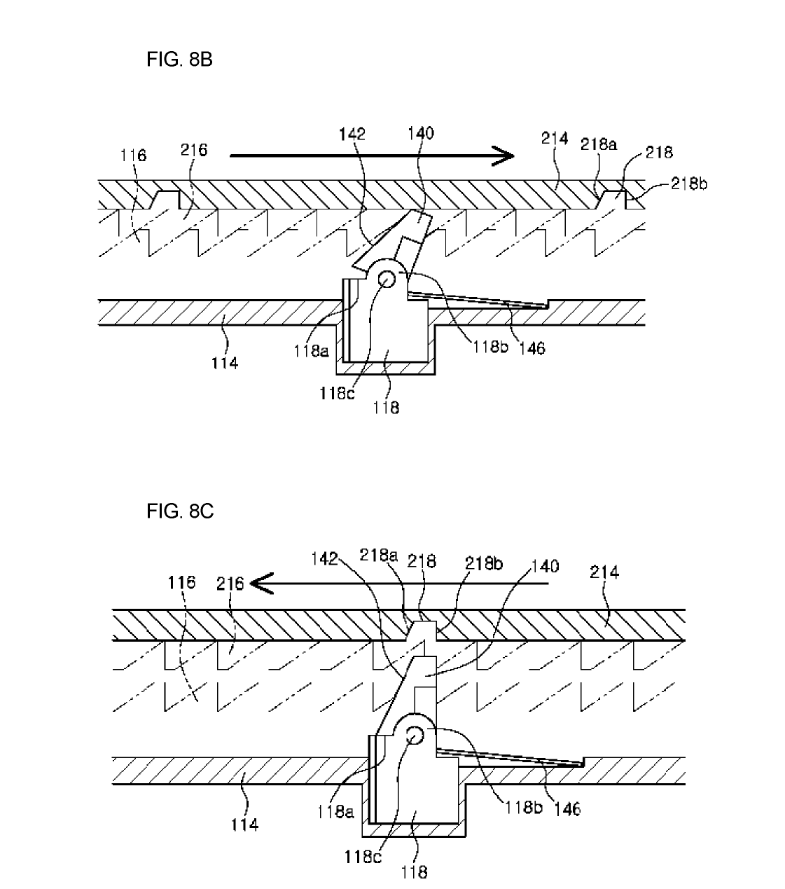

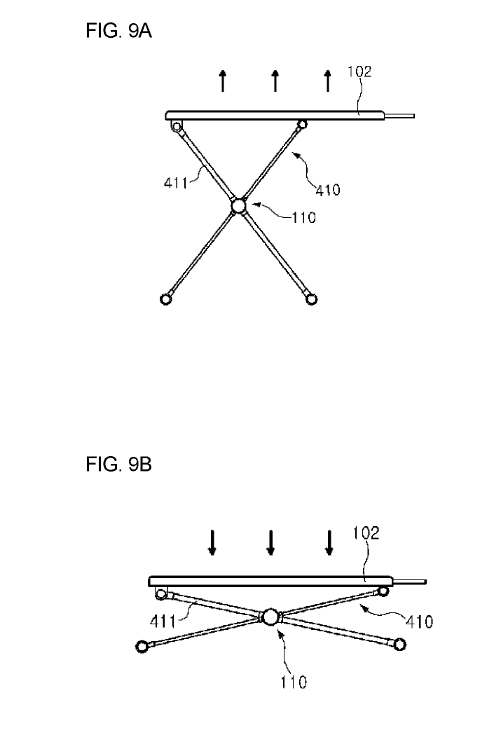

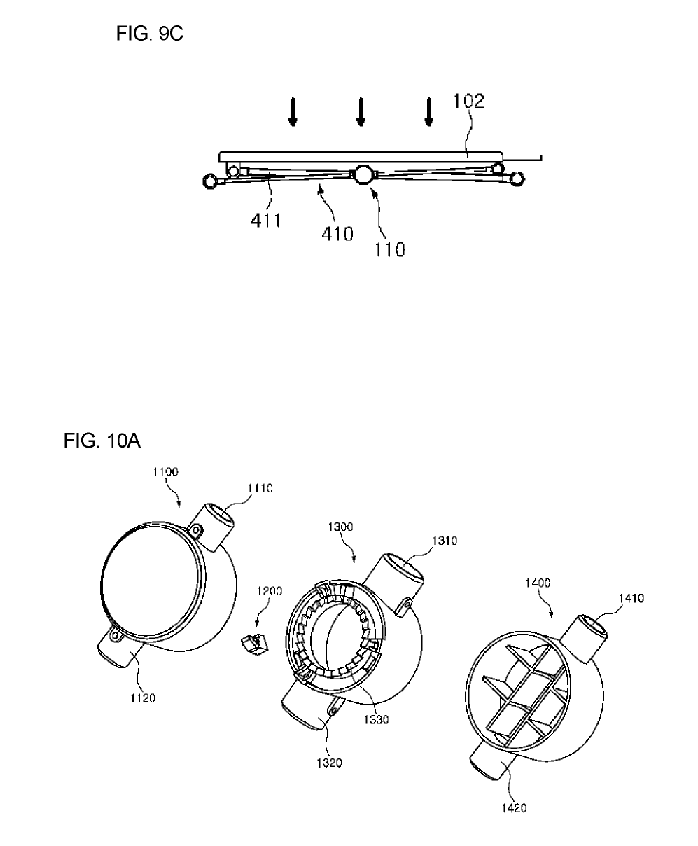

FIGS. 7A and 7B are views illustrating the operation of first and second brackets 111 and 210 of the height adjustment apparatus 100 according to the first embodiment of the present invention. FIGS. 8A and 8B are views illustrating the operation of the first one-way stopper 140 of the height adjustment apparatus 100. FIGS. 9A through 9C are views illustrating the operation of contracting the height adjustment apparatus 100.

As shown in these drawings, in the height adjustment apparatus 100, the first gear-teethed part 116 of the first bracket 111 engages with the second gear-teethed part 216 of the second bracket 210. Each first protrusion 120 of the first bracket 111 is maintained in the state of being in close contact with a second end of the corresponding second locking member 220 of the second bracket 210 which is opposite to the guide surface 220a formed on the first end of the second locking member 220. Each first locking member 124 of the first bracket 111 is in the state of being in close contact with a second end of the second protrusion 224 of the second bracket 210 which is opposite to the guide surface 224a formed on the first end of the second protrusion 224.

Furthermore, the first one-way stoppers 140 of the first bracket 111 are maintained in the state of being inserted in the corresponding locking depressions 218 formed in the mounting surface 214 of the second bracket 210.

In this state, when a user wants to adjust the height of the upper board 102, the user holds the upper board 102 and lifts it upwards. Then, the second and third brackets 210 and 310 rotate with respect to the first bracket 111, and the height adjustment apparatus 100 which has been in the contracted state is extended.

That is, the first gear-teethed part 116 of the first bracket 111 and the second gear-teethed part 216 of the second bracket 210 pass over the inclined surfaces of the gear teeth of each other and move relative to each other, thus allowing the height adjustment apparatus 100 to be extended. Here, because the inclined surface is formed on only one side of each gear tooth of the first and second gear-teethed parts 116 and 216, each of the first and second brackets 111 and 210 can rotate only in one direction and cannot rotate in the reverse direction.

Here, when the first gear-teethed part 116 of the first bracket 111 and the second gear-teethed part 216 of the second bracket 210 pass over the inclined surfaces of the gear teeth of each other, the first bracket 111 and the second bracket 210 move away from each other. However, because the second and third support rods 420 and 430 elastically push the second and third brackets 210 and 310 towards the first bracket 111, the second and third brackets 210 and 310 move away from the first bracket 111 only by the distance equal to the height of the inclined surfaces of the first and second gear-teethed parts 116 and 216, rather than being completely removed from the first bracket 111. The second and third brackets 210 and 310 which have slightly moved away from the first bracket 111 are returned to their original states by the elastic force of the second and third support rods 420 and 430.

Furthermore, when the second and third brackets 210 and 310 rotate with respect to the first bracket 111, the first one-way stoppers 140 of the first bracket 111 are moved along the inclined surfaces 218a of the corresponding locking depressions 218 of the second bracket 210 and removed from the locking depressions 218. At this time, each first one-way stopper 140 compresses the elastic member 146 and rotates around the hinge 118c in the direction opposite to the direction in which the first bracket 111 rotates with respect to the second bracket 210. Thereafter, the first one-way stoppers 140 come into close contact with the mounting surface 214 of the second bracket 210. In this state, the second bracket 210 rotates with respect to the first bracket 111.

As such, when the upper board 102 is lifted, the first bracket 111 is rotated by the first support rod 411 which is coupled to the connection member 413 fastened to the lower surface of the upper board 102. Simultaneously, the second and third brackets 210 and 310 rotate with respect to the first bracket 111. The user can adjust the height of the upper board 102 to a desired degree.

Furthermore, when the user who has held the upper board 102 and lifted it to a desired height releases the upper board, the first gear-teethed part 116 of the first bracket 111 is locked to the second gear-teethed part 216 of the second bracket 210 at that position, so that the upper board 102 is retained at the adjusted height.

Conversely, when it is desired to contract the height adjustment apparatus 100, the user holds the upper board 102 and lifts it to the uppermost position. Then, the first protrusions 120 of the first bracket 111 move onto the corresponding second locking members 220 along the guide surfaces 220a of the second locking members 220 and engage with the upper portions of the second locking members 220. Simultaneously, the first locking members 124 of the first bracket 111 move onto the corresponding second protrusions 224 of the second bracket 210 along the guide surfaces 224a of the second protrusions 224 and engage with the upper portions of the second protrusions 224.

As such, because the first protrusions 120 are disposed at the upper portions of the corresponding second locking members 220 and the first locking members 124 are disposed at the upper portions of the corresponding second protrusions 224, the second bracket 210 moves away from the first bracket 111 by a predetermined distance. Hereby, the first gear-teethed part 116 is disengaged from the second gear-teethed part 216. In addition, when the second bracket 210 moves away from the first bracket 111 by a predetermined distance, the first one-way stoppers 140 are rotated around the hinge 118c by the elastic force of the elastic members 146 and seated onto the stop protrusion 118a of the mounting block 118. Thereafter, the first one-way stoppers 140 are maintained in the upright state.

In addition, the mounting surface 214 of the second bracket 210 is supported on the upper ends of the first one-way stoppers 140 which are in the upright state. In this state, when the user moves the upper board 102 downwards, the second and third brackets 210 and 310 rotate with respect to the first bracket 111 in the direction opposite to the direction in which they rotate around the first bracket 111 when the upper board 102 moves upwards. Thus, the height adjustment apparatus 100 is contracted.

When the second and third brackets 210 and 310 which have rotated around the first bracket 111 are returned to their original positions, the first one-way stoppers 140 are inserted into the corresponding locking depressions 218 to which the first one-way stoppers 140 had been locked at first. Thereafter, the first one-way stoppers 140 are supported by the stop surfaces 218b of the locking depressions 218. Simultaneously, the first and second gear-teethed parts 116 and 216 engage with each other, so that the height adjustment apparatus 100 retains the contracted state.

Furthermore, the rear ends of the first protrusions 120 of the first bracket 111 are stopped by the corresponding second locking members 220 of the second bracket 210, and the rear ends of the first locking members 124 of the first bracket 111 are stopped by the second protrusions 224 of the second bracket 210, such that the second and third brackets 210 and 310 can no longer rotate with respect to the first bracket 111.

In this state, when the user lifts the upper board 102 upwards, the first one-way stoppers 140 are removed from the locking depressions 218, and each first one-way stopper 140 rotates around the hinge 118c and comes into close contact with the mounting surface 214. The first and second gear-teethed parts 116 and 216 of the first and second brackets 111 and 210 pass over the gear teeth of each other and move relative to each other without the first and second brackets 111 and 210 being completely spaced apart from each other.

That is, while the height of the upper board 120 is adjusted, the first protrusions 120 and the first locking members 124 of the first bracket 111 reciprocate between the second locking members 220 and the second protrusions 224 of the second bracket 210. When the height adjustment apparatus 100 is extended to lift the upper board 120, the first one-way stoppers 140 move after they rotate downwards around the hinges 118c, so that the first and second gear-teethed parts 116 and 216 are prevented from being completely disengaged from each other. When each first one-way stopper 140 moves in the reverse direction, it is rotated around the hinge 118c and returned to its original state, that is, to the upright state. In this state, the first and second brackets 111 and 210 are maintained in the state of being moved away from each other. Hence, the first and second gear-teethed parts 116 and 216 are also maintained in the state of being disengaged from each other, thus enabling the height adjustment apparatus 100 to be contracted.

Therefore, when the user holds the upper board 102 and lifts it, the height adjustment apparatus 100 is extended by a degree with which the user lifts the upper boards 102. When the upper board 102 is lifted to the uppermost position, the first and second gear-teethed parts 116 and 216 are disengaged from each other, thus allowing the height adjustment apparatus 100 to be contracted, so that the upper board 102 can move downwards by its own weight.

Meanwhile, unlike the first embodiment, the construction provided for the first bracket 111 may be formed in one of the second and third brackets 210 and 310. In this case, the construction of the second bracket 210 of the first embodiment is provided in the first bracket 111.

### Second Embodiment

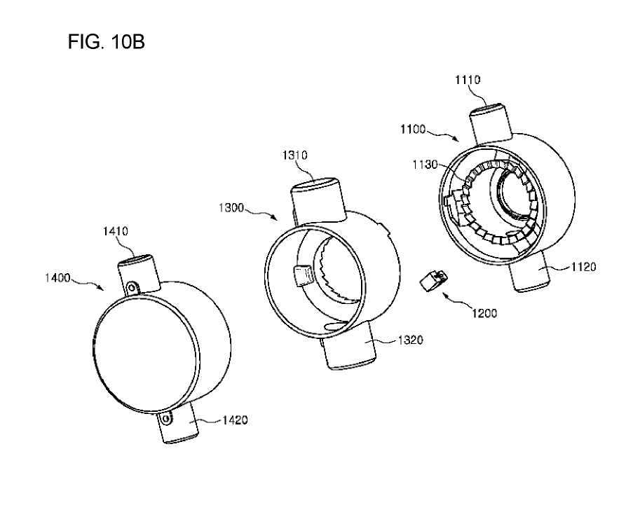

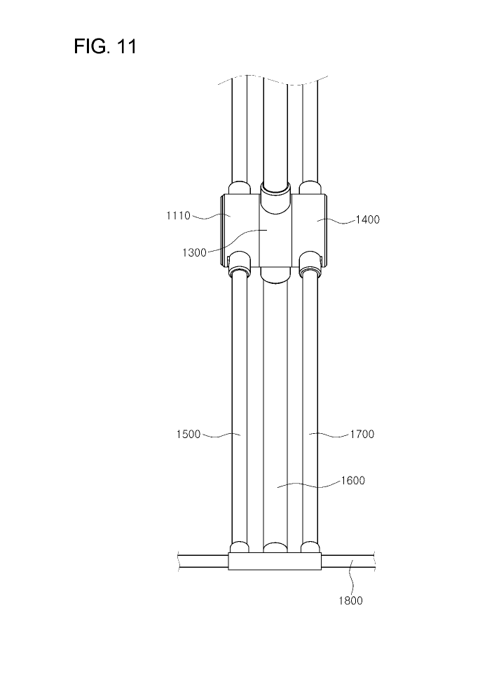

FIG. 10 is an exploded perspective view illustrating an actuating unit of a height adjustment apparatus, according to a second embodiment of the present invention. The height adjustment apparatus of the second embodiment includes a fourth bracket 1100, a fifth bracket 1300 and a sixth bracket 1400. Fourth coupling parts 1110 and 1120 are provided on the circumferential outer surface of the fourth bracket 1100 at diametrically opposite positions. As shown in FIG. 11, a fourth support rod 1500 which passes through the body of the fourth bracket 1100 is inserted through the fourth coupling parts 1110 and 1120. A third gear-teethed part 1130 having an annular shape is provided in the fourth bracket 1100 at a side facing the fifth bracket 1300.

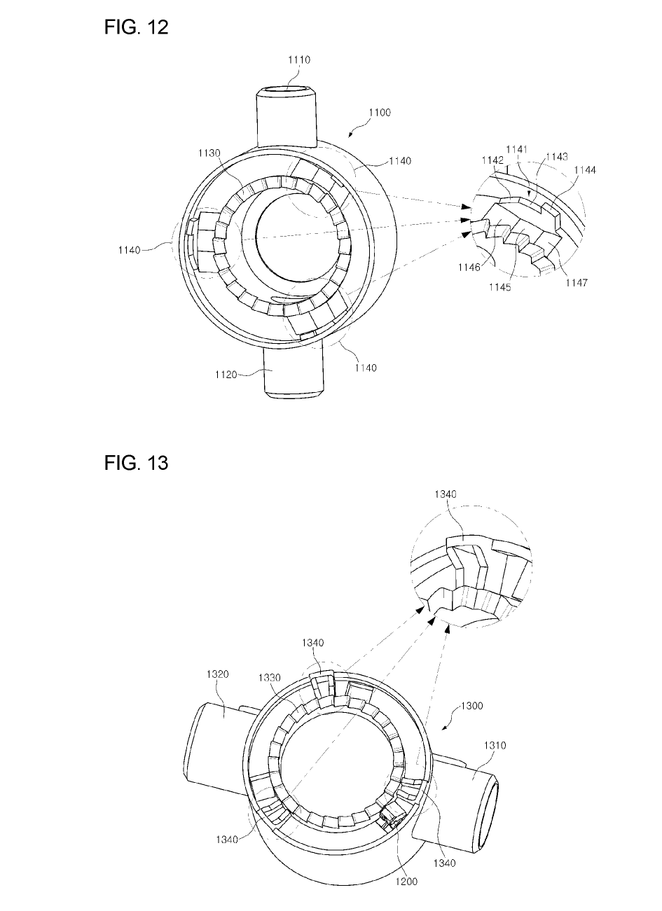

Furthermore, as shown in FIG. 12, in the fourth bracket 1100, locking release parts 1140 are formed outside the third gear-teethed part 1130 along the periphery of the third gear-teethed part 1130 at positions spaced apart from each other at regular angular intervals. Each locking release part 1140 includes a locking protrusion 1141 and a depression 1145.

The locking protrusion 1141 includes an inclined portion 1142 which is contiguous at a first end thereof with the bottom, and a planar portion 1143 which extends from a second end of the inclined portion 1142. The locking protrusion 1141 further includes a stopper 1144 which is provided on the end of the planar portion 1143 that is opposite to the inclined portion 1142.

In addition, inclined surfaces 1146 and 1147 are formed at both sides in the depression 1145 such that both ends of the depression 1145 are contiguous with the bottom on which the locking protrusion 1141 is provided.

Meanwhile, fifth coupling parts 1310 and 1320 are provided on the circumferential outer surface of the fifth bracket 1300 at diametrically opposite positions. A fifth support rod 1600 is inserted through the fifth coupling parts 1310 and 1320 and passes through the body of the fifth bracket 1300 such that the fifth support rod 1600 crosses over the fourth support rod 1500.

Furthermore, a fourth gear-teethed part 1330 having an annular shape is provided in the fifth bracket 1300 at a side facing the fourth bracket 1100. The fourth gear-teethed part 1330 engages with the third gear-teethed part 1130 of the fourth bracket 1100.

As shown in FIG. 13, in the fifth bracket 1300, locking protrusions 1340 are provided outside the fourth gear-teethed part 1330 along the periphery of the fourth gear-teethed part 1330 at positions spaced apart from each other at regular angular intervals. The locking protrusions 1340 of the same number as the locking release parts 1140 are disposed at positions corresponding to the locking release parts 1140.

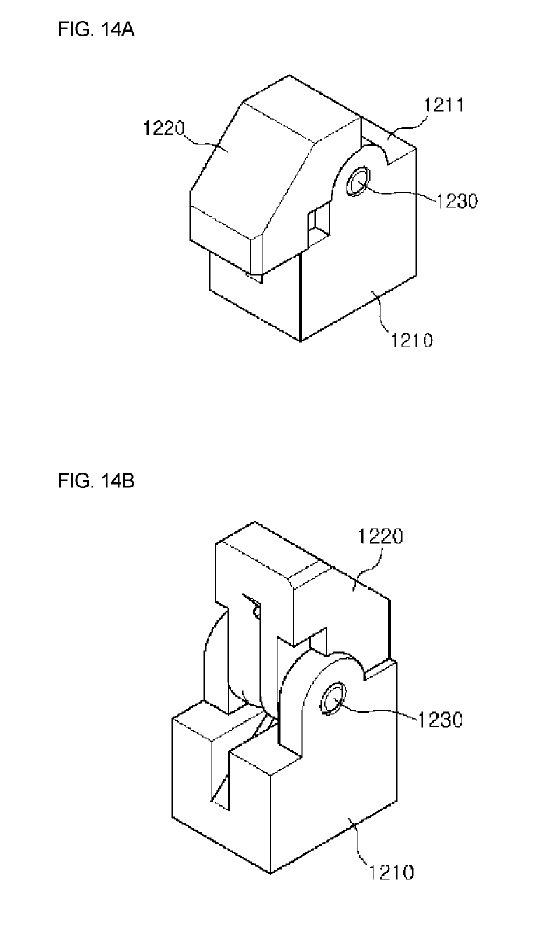

As shown in FIG. 14A, a second one-way stopper 1200 is disposed adjacent to each locking protrusion 1340. The second one-way stopper 1200 is constructed such that the upper end thereof elastically rotates only in one direction around a mounting block 1210 which is fastened to the fifth bracket 1300.

Furthermore, a spring is provided between a rotating member 1220 and the mounting block 1210, such that restoring force is applied to the second one-way stopper 1220, as shown in FIG. 14b.

Meanwhile, sixth coupling parts 1410 and 1420 are provided on the circumferential outer surface of the sixth bracket 1400 at diametrically opposite positions. A sixth support rod 1700 is inserted through the sixth coupling parts 1410 and 1420 and passes through the body of the sixth bracket 1400 such that the sixth support rod 1700 is parallel with the fourth support rod 1500.

The upper ends of the fourth and sixth support rods 1500 and 1700 are fastened to a top support (not shown) such that a distance therebetween is maintained constant. The lower ends of the fourth and sixth support rods 1500 and 1700 are fastened to a bottom support 1800 such that a distance therebetween is maintained constant.

Therefore, as shown in FIG. 11, the fourth bracket 1100, the fifth bracket 1300 and the sixth brackets 1400 are coupled to each other by the fourth support rod 1500 and the sixth support rod 1700.

The operation of the height adjustment apparatus according to the second embodiment of the present invention having the above-mentioned construction will be explained below.

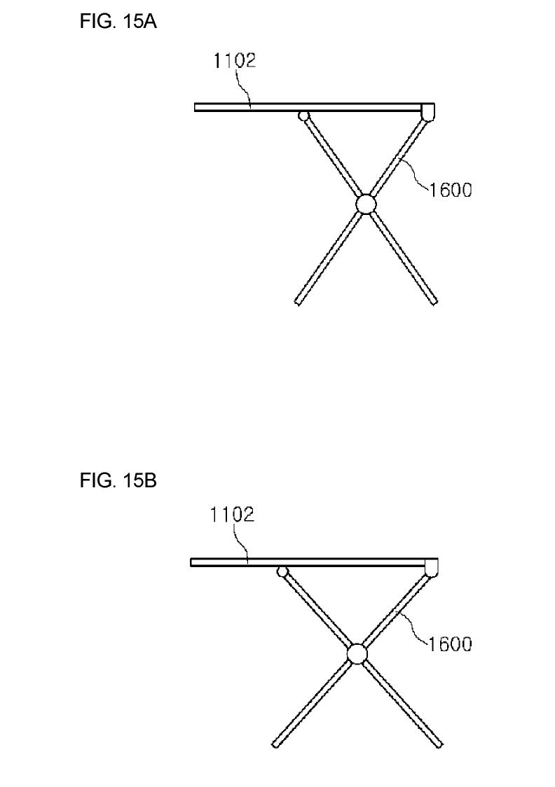

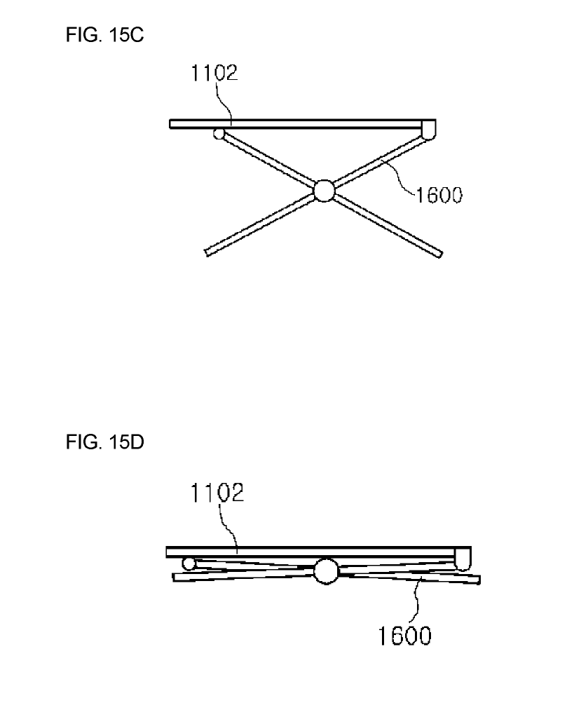

FIG. 15 illustrates the operation of the height adjustment apparatus according to the second embodiment. As shown in the drawing, an upper board 1102 is placed on the upper end of the height adjustment apparatus. The upper end of the fifth support rod 1600 is fastened to the lower surface of the upper board 1102.

As shown in FIG. 15D, the height adjustment apparatus is in the contracted state at first. In this case, the third gear-teethed part 1130 of the fourth bracket 1100 engages with the fourth gear-teethed part 1330 of the fifth bracket 1300. Furthermore, the locking protrusions 1340 of the fifth bracket 1300 are in the state of being in contact with the bottom of the fourth bracket 1100 behind the rear ends of the corresponding locking protrusions 1141.

When the user lifts the upper board 1102 to adjust the height thereof, the height adjustment apparatus is extended by its own weight. Here, the third gear-teethed part 1130 of the fourth bracket 1100 and the fourth gear-teethed part 1330 of the fifth bracket 1300 pass over the inclined surfaces of the gear teeth of each other and move relative to each other, thus allowing the height adjustment apparatus to be extended.

When the third gear-teethed part 1130 of the fourth bracket 1100 and the fourth gear-teethed part 1330 of the fifth bracket 1300 pass over the inclined surfaces of each other, the fourth bracket 1100 and the fifth bracket 1300 slightly move away from each other, but they are not completely separated from each other because the fourth support rod 1500 and the sixth support 1700 elastically support the fourth bracket 1100 and the fifth bracket 1300.

If the user stops to lift the upper board 1102 when it reaches a desired height, the third gear-teethed part 1130 of the fourth bracket 1100 is locked to the fourth gear-teethed part 1330 of the fifth bracket 1300, so that the upper board 1102 is retained at the adjusted height, as shown in FIG. 15B or 15C.

Here, when the height adjustment apparatus is in the contracted state, the rotating members 1220 of the second one-way stoppers 1200 are in contact with the bottom surface of the fourth bracket 1100 and are in the state of having rotated (bent) downwards. When the height adjustment apparatus is extended from this state, the second one-way stoppers 1200 rotate along with the fifth bracket 1300 while the rotating members 1220 maintain the above-mentioned state. Meanwhile, to contract the height adjustment apparatus which has been extended, the user lifts the upper board 1102 to the uppermost position, as shown in FIG. 15A. Then, the fifth bracket 1300 further rotates with respect to the fourth bracket 1100, so that the locking protrusions 1340 of the fifth bracket 1300 move onto the inclined portions 1142 and the planar portions 1143 of the corresponding locking protrusions 1141 of the fourth bracket 1100 and then are stopped to the stoppers 1144 of the locking protrusions 1141.

Thus, due to the height of the locking protrusions 1340 and 1141, the third gear-teethed part 1130 of the fourth bracket 1100 is completely removed from the fourth gear-teethed part 1330 of the fifth bracket 1300. Simultaneously, the second one-way stoppers 1200 move along the corresponding inclined surfaces 1146 and are inserted into the depressions 1145. Hereby, as shown in FIG. 14B, the rotating members 1220 of the second one-way stoppers 1200 rotate upwards, thus maintaining the state in which the fourth and fifth brackets 1100 and 1300 move away from each other.

In this state, that is, when the fourth and fifth brackets 1100 and 1300 are in the state of being completely spaced apart from each other, if the user releases the upper board 1102, the height adjustment apparatus is contracted by its own weight and the weight of the upper board 1102, as shown in FIG. 15D. In this process, the fifth bracket 1300 reversely rotates and the second one-way stoppers 1200 move along the inclined surfaces 1146 and are removed from the depressions 1143. Thereafter, the second one-way stoppers 1200 rotate along with the fifth bracket 1300 and are inserted into the depressions 1141 of the neighboring locking release parts 1140 via the corresponding inclined surfaces 1147 of the depressions 1141.

Therefore, the third gear-teethed part 1130 of the fourth bracket 1100 engages with the fourth gear-teethed part 1330 of the fifth bracket 1300 again.

Furthermore, the locking protrusions 1340 are locked to the rear ends of the stoppers 1144 of the locking protrusions 1141 of the neighboring locking release part 1140. When the user lifts the upper board 1102 again, the second one-way stoppers 1200 are moved along the corresponding inclined surfaces 1147 and removed from the depressions 1145, and the rotating members 1220 of the second one-way stoppers 1200 are rotated downwards again. The fourth bracket 1100 and the fifth bracket 1300 rotate with respect to each other in the state in which they are not completely spaced apart from each other. Thus, the third gear-teethed part 1130 of the fourth bracket 1100 and the fourth gear-teethed part 1330 of the fifth bracket 1300 pass over the inclined surfaces of the gear teeth of each other and move relative to each other while maintaining the engaged state.

As such, when the height of the height adjustment apparatus is adjusted, the locking protrusions 1340 of the fifth bracket 1300 reciprocate between the adjacent locking release parts 1140 of the fourth bracket 1100. Here, when the height adjustment apparatus is extended, the second one-way stoppers 1200 move in the state of having rotated downwards so as to prevent the three and fourth gear-teethed parts 1130 and 1330 from being disengaged from each other. When the second one-way stoppers 1200 move in the reverse direction, the rotating members 1220 rotate upwards, thus moving the fourth bracket 1100 away from the fifth bracket 1300, thereby enabling the height adjustment apparatus to be contracted.

In other words, the height adjustment apparatus of the present invention is extended by a degree with which the user applies force to the upper board 1102 upwards, and then it is retained at that height. When the upper board 1102 is lifted to the uppermost height, the three and fourth gear-teethed parts 1130 and 1330 are disengaged from each other, thus allowing the height adjustment apparatus to be contracted by its own weight.

Meanwhile, the height adjustment apparatus of the second embodiment may be constructed such that the positions of the fourth bracket 1100 and the fifth bracket 1300 are switched. That is, the fifth bracket 1300 having the second on-way stoppers 1200 may be disposed at the position of the fourth bracket 1100, and the fourth bracket 1100 may be disposed at the position of the fifth bracket 1300.

In this case, the sixth bracket 1400 is coupled to the rear side of the fourth bracket 1100 that is changed in position. The operation of this modified construction is the same as that of the second embodiment which was stated above.

In the embodiments, although the height adjustment apparatus according to the present invention has been illustrated as being used for an ironing board, the present invention is not limited to this. The present invention can be modified in various manners without departing from the scope and spirit of the invention as disclosed in the accompanying claims, for example, it may be used for a table, a desk, and so on. These modifications must be regarded as falling within the bounds of the present invention.

As described above, a height adjustment apparatus according to the present invention is constructed such that the height thereof is adjusted in multi-steps using a gear teeth engagement structure. Furthermore, when an upper board reaches the uppermost position, the gear teeth are disengaged from each other, thus enabling the height adjustment apparatus to be contracted such that the upper board is disposed at the lowermost position. Therefore, a user can easily adjust the upper board only through a single process.

Furthermore, second and third brackets are coupled to a first bracket which is disposed therebetween and are elastically supported by second and third support rods which are fastened to the second and third brackets. Thus, because the second and third elastic rods function as elastic members, a separate coupling means for coupling the brackets is not required. Therefore, the structure of the height adjustment apparatus is simplified, thereby reducing the production cost, and facilitating maintenance and repair.

In other words, the second and third support rods are slightly bent inwards based on the positions at which they are fastened to the second and third brackets. Thus, the second and third brackets are fastened to both ends of the first bracket by the elastic force of the second and third support rods.

As well, first one-way stoppers are provided in the first bracket. When the second and third brackets rotate in a predetermined direction, the first one-way stoppers allow the second and third brackets to freely rotate around the first bracket which is interposed therebetween. That is, when the second and third brackets rotate in a predetermined direction within a predetermined range, the gear teeth are disengaged from each other, thus enabling the height adjustment apparatus to be easily contracted.

What is claimed is:

1. A height adjustment apparatus, comprising:
an actuating unit controlling a height of the height adjustment apparatus; and
a frame unit coupled to the actuating unit, the frame unit being adjusted in height by contraction or extension thereof.

2. The height adjustment apparatus as set forth in claim 1, wherein the actuating unit comprises:
a first bracket provided at a medial portion of the actuating unit;
a second bracket coupled to a first end of the first bracket; and
a third bracket coupled to a second end of the first bracket.

3. The height adjustment apparatus as set forth in claim 2, wherein the first bracket has a cylindrical shape,
wherein first coupling parts are respectively provided on upper and lower portions of a circumferential outer surface of the first bracket,
a mounting plate is provided in the first end of the first bracket,
a first gear-teethed part is provided on the mounting plate, and
a pair of first protrusions is provided at diametrically opposite positions on a circumferential outer surface of the first gear-teethed part, the first protrusions extending predetermined lengths outside the first gear-teethed part.

4. The height adjustment apparatus as set forth in claim 3, wherein mounting depressions are formed in a circumferential inner surface of both ends of the first bracket, each mounting depression having a predetermined depth, and first locking members are provided in the mounting depression which is adjacent to the second bracket, the first locking members being disposed at positions perpendicular to the first protrusions based on a center of the first bracket.

5. The height adjustment apparatus as set forth in claim 3, wherein a first one-way stopper is provided on the mounting plate, the first one-way stopper being disposed inside the first gear-teethed part.

6. The height adjustment apparatus as set forth in claim 5, wherein a mounting block is fastened to the mounting plate of the first bracket, the first one-way stopper is rotatably coupled to the mounting block by a hinge, and an elastic member is fitted over the hinge.

7. The height adjustment apparatus as set forth in claim 6, wherein
a support protrusion is provided on the mounting block so that the hinge is fitted into the support protrusion,
a stop protrusion is provided on the mounting block on one side of the support protrusion, and
an inclined surface is formed on a first side of the first one-way stopper.

8. The height adjustment apparatus as set forth in claim 6, wherein the elastic member comprises a torsion spring.

9. The height adjustment apparatus as set forth in claim 5, wherein the first one-way stopper comprises three first one-way stoppers spaced apart from each other at regular angular intervals.

10. The height adjustment apparatus as set forth in claim 2, wherein the second bracket has a cylindrical shape and is inserted into the mounting depression formed in the first end of the first bracket,
wherein second coupling parts are respectively provided on upper and lower portions of a circumferential outer surface of the second bracket,
a mounting surface is formed inside the second bracket,
a second gear-teethed part is provided on the mounting surface, the second gear-teethed part engaging with the first gear-teethed part of the first bracket,
a locking depression is formed in the mounting surface and disposed inside the second gear-teethed part so that the first one-way stopper is removably locked to the locking depression, and
second locking members are provided in the second bracket and disposed outside the second gear-teethed part, the second locking members corresponding to the first protrusions of the first bracket.

11. The height adjustment apparatus as set forth in claim 10, wherein second protrusions protrude from a second end of the second bracket in an axial direction, the second protrusions corresponding to the first locking members of the first bracket.

12. The height adjustment apparatus as set forth in claim 10, wherein an inclined surface is formed in one end of the locking depression.

13. The height adjustment apparatus as set forth in claim 10, further comprising:
a cover covering a first end of the second bracket which is opposite to the second end thereof in which the mounting surface is provided.

14. The height adjustment apparatus as set forth in claim 2, wherein the third bracket has a cylindrical shape and is inserted into the mounting depression formed in the second end of the first bracket,
wherein third coupling parts are provided at diametrically opposite positions on a circumferential outer surface of the third bracket.

15. The height adjustment apparatus as set forth in claim 1, wherein the frame unit comprises:
a first support rod coupled to the first bracket of the actuating unit;
a second support rod coupled to the second bracket of the actuating unit; and
a third support rod coupled to the third bracket of the actuating unit.

16. The height adjustment apparatus as set forth in claim 15, wherein
the first support rod is inserted through the first coupling parts provided on the upper and lower portions of the first bracket, such that the first support rod protrudes upwards and downwards from the first bracket,
the second support rod is inserted through the second coupling parts provided on the upper and lower portions of the second bracket, such that the second support rod protrudes upwards and downwards from the second bracket, and
the third support rod is inserted through the third coupling parts provided on the upper and lower portions of the third bracket, such that the third support rod protrudes upwards and downwards from the third bracket.

17. The height adjustment apparatus as set forth in claim 16, wherein
a connection member is coupled to an upper end of the first support rod, the connection member being fastened to an upper board, and
a first bottom support is coupled to a lower end of the first support rod, the first bottom support being supported on a ground.

18. The height adjustment apparatus as set forth in claim 16, wherein the second and third support rods are respectively coupled to the second and third brackets, wherein upper and lower ends of the second and third support rods which protrude from the second and third brackets are curved inwards such that a distance between the second and third support rods is reduced from the second and third brackets to the upper and lower ends thereof.

19. The height adjustment apparatus as set forth in claim 18, wherein
a top support is coupled to the upper ends of the second and third support rods, the top support supporting the upper board thereon, and
a second bottom support is coupled to the lower ends of the second and third support rods, the second bottom support being supported on the ground.

20. A height adjustment apparatus, comprising:
a fourth bracket, having: a fourth bracket body; fourth coupling parts provided on the fourth bracket body so that a fourth support bar is inserted through the fourth coupling parts and passes through the fourth bracket body; a third gear-teethed part having an annular shape and provided in the fourth bracket body; a plurality of locking protrusions provided in the fourth bracket body around a periphery of the third gear-teethed part at positions spaced apart from each other at regular angular intervals, each of the locking protrusions having an inclined portion; and a plurality of depressions formed in the fourth bracket body around the periphery of the third gear-teethed part at positions spaced apart from each other at regular angular intervals;
a fifth bracket, having: a fifth bracket body; fifth coupling parts provided on the fifth bracket body so that a fifth support bar is inserted through the fifth coupling parts and passes through the fifth bracket body; a fourth gear-teethed part having an annular shape and provided in the fifth bracket body; and a plurality of locking protrusions provided in the fifth bracket body around a periphery of the fourth gear-teethed part at positions spaced apart from each other at regular angular intervals, wherein the fourth bracket is coupled to a first end of the fifth bracket such that the third gear-teethed part engages with the fourth gear-teethed part;
second one-way stoppers provided in the fifth bracket around the periphery of the fourth gear-teethed part at positions spaced apart from each other at regular angular intervals, each of the second one-way stoppers being constructed such that an upper end thereof is elastically bent only in one direction; and
a sixth bracket coupled to a second end of the fifth bracket, the sixth bracket having: a sixth bracket body; and sixth coupling parts provided on the sixth bracket body so that a sixth support bar is inserted through the sixth coupling parts and passes through the sixth bracket body,
wherein upper ends of the fourth and sixth support rods and lower ends of the fourth and sixth support rods are respectively fastened to top and bottom supports.

21. A height adjustment apparatus, comprising:
a fourth bracket, having: a fourth bracket body; fourth coupling parts provided on the fourth bracket body so that a fourth support bar is inserted through the fourth coupling parts and passes through the fourth bracket body; a third gear-teethed part having an annular shape and provided in the fourth bracket body; and a plurality of locking protrusions provided in the fourth bracket body around a periphery of the third gear-teethed part at positions spaced apart from each other at regular angular intervals;
a fifth bracket, having: a fifth bracket body; fifth coupling parts provided on the fifth bracket body so that a fifth support bar is inserted through the fifth coupling parts and passes through the fifth bracket body; a fourth gear-teethed part having an annular shape and provided in the fifth bracket body; and a plurality of locking protrusions provided in the fifth bracket body around a periphery of the fourth gear-teethed part at positions spaced apart from each other at regular angular intervals, each of the locking protrusions having an inclined portion; and a plurality of depressions formed in the fifth bracket body around the periphery of the fourth gear-teethed part at positions spaced apart from each other at regular angular intervals, wherein the fourth bracket is coupled to a first end of the fifth bracket such that the third gear-teethed part engages with the fourth gear-teethed part;
second one-way stoppers provided in the fourth bracket around the periphery of the third gear-teethed part at positions spaced apart from each other at regular angular intervals, each of the second one-way stoppers being constructed such that an upper end thereof is elastically bent only in one direction; and
a sixth bracket coupled to a second end of the fifth bracket, the sixth bracket having: a sixth bracket body; and sixth coupling parts provided on the sixth bracket body so that a sixth support bar is inserted through the sixth coupling parts and passes through the sixth bracket body,
wherein upper ends of the fourth and sixth support rods and lower ends of the fourth and sixth support rods are respectively fastened to top and bottom supports.
